(19) United States
(12) Patent Application Publication
(10) Pub. No.: US 2026/0303405 A1
(43) Pub. Date: Oct. 1, 2026

(54) IN-VEHICLE RELAY DEVICE, SLEEP CONTROL METHOD, AND SLEEP CONTROL PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP); TOYOTA JIDOSHA KABUSHIKI KAISHA, Toyota-shi, Aichi (JP)

(72) Inventors: Kentaro ASHIBE, Yokkaichi-shi, Mie (JP); Darmawan GO, Yokkaichi-shi, Mie (JP); Tomohiro OTSU, Yokkaichi-shi, Mie (JP); Hirofumi URAYAMA, Yokkaichi-shi, Mie (JP); Shu ISHIZUKA, Toyota-shi, Aichi (JP); Yoshinobu KUROYA, Toyota-shi, Aichi (JP); Kazuya SUGIYAMA, Toyota-shi, Aichi (JP); Yuichiroh ITATSU, Toyota-shi, Aichi (JP); Daigo ISHII, Toyota-shi, Aichi (JP); Hiroya ANDOU, Toyota-shi, Aichi (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP); TOYOTA JIDOSHA KABUSHIKI KAISHA, Toyota-shi, Aichi (JP)

(21) Appl. No.: 19/118,993

(22) PCT Filed: Oct. 16, 2023
(86) PCT No.: PCT/JP2023/037346

§ 371 Date: Apr. 24, 2026

(30) Foreign Application Priority Data
Oct. 27, 2022 (JP) 2022-172049

(51) Int. Cl. H04L 12/46

(52) U.S. Cl. CPC H04L 12/46

(57) ABSTRACT

An in-vehicle relay device includes: a plurality of communication ports configured to be respectively connected to a plurality of in-vehicle functional units; a plurality of communication circuits provided respectively corresponding to the plurality of communication ports and configured to communicate with the in-vehicle functional units via the corresponding communication ports; an acquisition unit configured to acquire, functional unit information of a new functional unit, which is the in-vehicle functional unit whose addition is detected; and a sleep control unit configured to perform, selection processing for selecting, from among a plurality of types of sleep modes, a type of sleep mode to respectively apply to the communication circuit corresponding to the communication port to which the new functional unit is connected and to the communication circuit corresponding to the communication port to which the existing functional unit is connected.

### CROSS-REFERENCE TO RELATED APPLICATIONS

This application is the U.S. national stage of PCT/JP2023/037346 filed on Oct. 16, 2023, which claims priority of Japanese Patent Application No. JP 2022-172049 filed on Oct. 27, 2022, the contents of which are incorporated herein.

### TECHNICAL FIELD

The present disclosure relates to an in-vehicle relay device, a sleep control method, and a sleep control program.

### BACKGROUND

JP 2018-074243A discloses technology such as the following: A relay device (11) including a plurality of ports (P1 to P5) through which frames are transmitted and received, a switch unit (31) having a relay execution unit that selects one of the plurality of ports, based on a destination of a received frame, which is a frame received via one of the plurality of ports, and executes relay processing for transmitting the received frame from the selected port, and switchable between a first startup state in which the relay processing is executable by the relay execution unit and a first hibernation state which the relay processing is unexecutable by the relay execution unit, a plurality of PHY units (Y1 to Y5) each having a communication execution unit that executes a reception function for converting communication signals input from the ports into reception data and outputting the reception data to the switch unit and a transmission function for converting data transmitted from the switch unit into communication signals to be transmitted on a communication line and outputting the communication signals to the ports, capable of switching between a second startup state in which the reception function and the transmission function are executable by the communication execution unit and a second hibernation state in which the reception function and the transmission function are unexecutable by the communication execution unit, and set respectively corresponding to the plurality of ports, a first control unit (37) that, in a case where the switch unit is in the first hibernation state and the plurality of PHY units are each in the second hibernation state, transitions the PHY unit corresponding to the port at which the frame is detected from the second hibernation state to the second startup state, and a second control unit (38) that, in a case where the switch unit is in the first hibernation state and the plurality of PHY units are each in the second hibernation state, transitions the switch unit from the first hibernation state to the first startup state, when one of the plurality of PHY units transitions from the second hibernation state to the second startup state.

In an in-vehicle network, in-vehicle functional units such as ECUs may be added according to the user's needs. Here, for example, if the time required for the communication circuit corresponding to the communication port of the in-vehicle relay device to which a new in-vehicle functional unit is connected to transition from the sleep mode to the wakeup mode exceeds an allowable time for an application installed in the new in-vehicle functional unit to start, operation in the newly configured in-vehicle network may become unstable.

The present disclosure has been made in order to solve the above-described problem, and an object thereof is to provide an in-vehicle relay device, a sleep control method, and a sleep control program capable of realizing stable operation in a newly configured in-vehicle network.

### SUMMARY

A technology has been developed to achieve a reduction in power consumption in an in-vehicle relay device, by applying sleep control to communication circuits provided corresponding to communication ports.

An in-vehicle relay device according to the present disclosure including: a plurality of communication ports configured to be respectively connected to a plurality of in-vehicle functional units; a plurality of communication circuits provided respectively corresponding to the plurality of communication ports and configured to communicate with the in-vehicle functional units via the corresponding communication ports; an acquisition unit configured to acquire, when addition of one of the in-vehicle functional unit to an in-vehicle network including an existing functional unit, which is one or more of the in-vehicle functional units, is detected, functional unit information of a new functional unit, which is the in-vehicle functional unit whose addition is detected; and a sleep control unit configured to perform, based on the functional unit information of the new functional unit acquired by the acquisition unit, selection processing for selecting, from among a plurality of types of sleep modes, a type of sleep mode to respectively apply to the communication circuit corresponding to the communication port to which the new functional unit is connected and to the communication circuit corresponding to the communication port to which the existing functional unit is connected.

One aspect of the present disclosure can be realized not only as an in-vehicle relay device that includes such characteristic processing units, but also as a semiconductor integrated circuit that realizes a part or the entirety of the in-vehicle relay device, or a system that includes the in-vehicle relay device.

### EFFECTS

With the present disclosure, stable operation in the newly configured in-vehicle network can be realized.

### BRIEF DESCRIPTION OF THE DRAWINGS

FIG. 1 is a diagram showing an example of the configuration of an in-vehicle communication system according to an embodiment of the present disclosure.

FIG. 2 is a diagram showing an example of the configuration of the in-vehicle relay device according to the embodiment of the present disclosure.

FIG. 3 is a diagram showing an example of a sequence of sleep processing in an in-vehicle communication system according to an embodiment of the present disclosure.

FIG. 4 is a diagram showing an example of the communication circuit table saved in the in-vehicle relay device according to the embodiment of the present disclosure.

FIG. 5 is a diagram showing an example of the allowable wakeup time of each application in the in-vehicle communication system according to the embodiment of the present disclosure.

FIG. 6 is a diagram showing an example of the communication circuit table after the update processing by the in vehicle relay device according to the embodiment of the present disclosure.

FIG. 7 is a diagram showing an example of the condition table saved by the in-vehicle relay device according to the embodiment of the present disclosure.

FIG. 8 is a flowchart defining an operation procedure of the selection processing by the in-vehicle relay device according to the embodiment of the present disclosure.

FIG. 9 is a flowchart defining an operation procedure of sleep control in the in-vehicle relay device according to the embodiment of the present disclosure.

FIG. 10 is a diagram showing an example of a sleep control sequence in the in-vehicle communication system according to the embodiment of the present disclosure.

FIG. 11 is a diagram showing the configuration of a variation of the in-vehicle communication system according to the embodiment of the present disclosure.

FIG. 12 is a diagram showing a communication circuit table saved by the variation of the in-vehicle relay device according to the embodiment of the present disclosure.

FIG. 13 is a diagram showing the communication circuit table after update processing by the variation of the in-vehicle relay device according to the embodiment of the present disclosure.

### DETAILED DESCRIPTION OF PREFERRED EMBODIMENTS

First, the details of an embodiment of the present disclosure are listed and described.

In a first aspect, an in-vehicle relay device according to an embodiment of the present disclosure including: a plurality of communication ports configured to be respectively connected to a plurality of in-vehicle functional units; a plurality of communication circuits provided respectively corresponding to the plurality of communication ports and configured to communicate with the in-vehicle functional units via the corresponding communication ports; an acquisition unit configured to acquire, when addition of one of the in-vehicle functional unit to an in-vehicle network including an existing functional unit, which is one or more of the in-vehicle functional units, is detected, functional unit information of a new functional unit, which is the in-vehicle functional unit whose addition is detected; and a sleep control unit configured to perform, based on the functional unit information of the new functional unit acquired by the acquisition unit, selection processing for selecting, from among a plurality of types of sleep modes, a type of sleep mode to respectively apply to the communication circuit corresponding to the communication port to which the new functional unit is connected and to the communication circuit corresponding to the communication port to which the existing functional unit is connected.

In this way, by adopting a configuration in which the type of sleep mode to respectively apply to the communication circuits corresponding to a new functional unit and existing functional units is selected, based on the functional unit information of the new functional unit, the communication circuits corresponding to the new functional unit and the existing functional units can respectively be transitioned to an appropriate sleep mode that corresponds to the functional unit information of the new functional unit, when the sleep condition of the in-vehicle relay device is established. Thus, delay in the transition of the communication circuits corresponding to the new functional unit and the existing functional units to the wakeup mode can be suppressed, when the wakeup condition of the in-vehicle relay device is established. Accordingly, stable operation in the newly configured in-vehicle network can be realized.

In a second aspect according to the first aspect, a configuration is possible in which, the functional unit information includes application information relating to an application installed in the new functional unit, and the sleep control unit performs the selection processing, based on the application information of the new functional unit acquired by the acquisition unit.

With such a configuration, a sleep mode that corresponds to the application information of the new functional unit can be selected, as the type of sleep mode to respectively apply to the communication circuits corresponding to the new functional unit and the existing functional units.

In a third aspect according to the second aspect, a configuration is possible in which, the application information includes information relating to a type of the application.

With such a configuration, an appropriate sleep mode that corresponds to the type of application of the new functional unit can be used.

In a fourth aspect according to the second or the third aspect, a configuration is possible in which, the application information includes information relating to an allowable time for the application to start.

With such a configuration, an appropriate sleep mode that corresponds to the allowable time for an application installed in the new functional unit to start can be used.

In a fifth aspect according to any of the first through the fourth aspects, a configuration is possible in which, the acquisition unit further acquires functional unit information of the existing functional unit, and the sleep control unit performs the selection processing, based on the functional unit information of the new functional unit and the functional unit information of the existing functional unit acquired by the acquisition unit.

With such a configuration, in the selection processing, a more appropriate sleep mode that reflects the contents of the functional unit information of the existing functional units in addition to the functional unit information of the new functional unit can be selected.

In a sixth aspect according to any of the first through the fifth aspects, a configuration is possible in which, the in-vehicle relay device further including: a storage unit configured to store function correspondence information indicating a correspondence relationship between the communication circuit corresponding to the communication port to which the existing functional unit is connected and the functional unit information of the existing functional unit, wherein the acquisition unit, in a case of acquiring the functional unit information of the new functional unit, performs update processing for registering, in the function correspondence information in the storage unit, a correspondence relationship between the communication circuit corresponding to the communication port to which the new functional unit is connected and the functional unit information of the new functional unit, and the sleep control unit performs the selection processing, based on the function correspondence information after the update processing.

With such a configuration, selection processing can be performed with simple processing, using function correspondence information after update processing, for

In a seventh aspect according to any of the first through the sixth aspects, a configuration is possible in which, the in-vehicle relay device further including: a storage unit configured to store sleep mode correspondence information indicating the sleep mode to respectively apply to the plurality of communication circuits, wherein the acquisition unit, in a case of another new functional unit being added to the in-vehicle network, acquires functional unit information of the other new functional unit, and the sleep control unit performs the selection processing, based on the functional unit information of the other new functional unit acquired by the acquisition unit and the sleep mode correspondence information in the storage unit.

With such a configuration, at the time of performing selection processing using the functional unit information of another new functional unit, the sleep mode applied to each communication circuit in the most recent selection processing can be easily confirmed, by referring to the sleep mode correspondence information in the storage unit.

In an eighth aspect according to any of the first through the seventh aspects, a configuration is possible in which, the plurality of types of sleep modes include a first sleep mode and a second sleep mode in which power consumption of the communication circuits is smaller than in the first sleep mode, and when, in a state where the second sleep mode is selected as the sleep mode to apply to a predetermined plurality of the communication circuits, the new functional unit is connected to the communication port corresponding to at least one of the predetermined plurality of communication circuits, and the first sleep mode is selected as the sleep mode to apply to the communication circuit corresponding to the communication port to which the new functional unit is connected, the sleep control unit changes the sleep mode to apply to all of the remaining communication circuits of the predetermined plurality of communication circuits from the second sleep mode to the first sleep mode.

With such a configuration, when sleep control cannot be individually applied to a plurality of communication circuits due to specification constraints of the hardware or the like of the in-vehicle relay device, for example, the type of sleep mode to apply to the plurality of communication circuits can be correctly selected, and sleep control can be more stably applied.

In a ninth aspect, a sleep control method according to an embodiment of the present disclosure is a sleep control method for use in an in-vehicle relay device including a plurality of communication ports configured to be respectively connected to a plurality of in-vehicle functional units, and a plurality of communication circuits provided respectively corresponding to the plurality of communication ports and configured to communicate with the in-vehicle functional units via the corresponding communication ports, the method including: a step of acquiring, when addition of one of the in-vehicle functional units to an in-vehicle network including an existing functional unit, which is one or more of the in-vehicle functional units, is detected, functional unit information of a new functional unit, which is the in-vehicle functional unit whose addition is detected; and a step of performing, based on the acquired functional unit information of the new functional unit, selection processing for selecting, from among a plurality of types of sleep modes, a type of sleep mode to respectively apply to the communication circuit corresponding to the communication port to which the new functional unit is connected and to the communication circuit corresponding to the communication port to which the existing functional unit is connected.

In this way, by adopting a configuration in which the type of sleep mode to respectively apply to the communication circuits corresponding to a new functional unit and existing functional units is selected, based on the functional unit information of the new functional unit, the communication circuits corresponding to the new functional unit and the existing functional units can respectively be transitioned to an appropriate sleep mode that corresponds to the functional unit information of the new functional unit, when the sleep condition of the in-vehicle relay device is established. Thus, delay in the transition of the communication circuits corresponding to the new functional unit and the existing functional units to the wakeup mode can be suppressed, when the wakeup condition of the in-vehicle relay device is established. Accordingly, stable operation in the newly configured in-vehicle network can be realized.

(10) A sleep control program according to an embodiment of the present disclosure is a sleep control program for use in an in-vehicle relay device including a plurality of communication ports configured to be respectively connected to a plurality of in-vehicle functional units, and a plurality of communication circuits provided respectively corresponding to the plurality of communication ports and configured to communicate with the in-vehicle functional units via the corresponding communication ports, the program causing a computer to function as an acquisition unit configured to acquire, when addition of one of the in-vehicle functional units to an in-vehicle network including an existing functional unit, which is one or more of the in-vehicle functional units, is detected, functional unit information of a new functional unit, which is the in-vehicle functional unit whose addition is detected; and a sleep control unit configured to perform, based on the functional unit information of the new functional unit acquired by the acquisition unit, selection processing for selecting, from among a plurality of types of sleep modes, a type of sleep mode to respectively apply to the communication circuit corresponding to the communication port to which the new functional unit is connected and to the communication circuit corresponding to the communication port to which the existing functional unit is connected.

In this way, by adopting a configuration in which the type of sleep mode to respectively apply to the communication circuits corresponding to a new functional unit and existing functional units is selected, based on the functional unit information of the new functional unit, the communication circuits corresponding to the new functional unit and the existing functional units can respectively be transitioned to an appropriate sleep mode that corresponds to the functional unit information of the new functional unit, when the sleep condition of the in-vehicle relay device is established. Thus, delay in the transition of the communication circuits corresponding to the new functional unit and the existing functional units to the wakeup mode can be suppressed, when the wakeup condition of the in-vehicle relay device is established. Accordingly, stable operation in the newly configured in-vehicle network can be realized.

Hereinafter, embodiments of the present disclosure will be described with reference to the drawings. Note that, in the drawings, the same reference numerals are given to the same or corresponding components in the drawings, and redundant descriptions thereof are not repeated. Furthermore, at least parts of the embodiments described below may be suitably combined.

### In-Vehicle Communication System

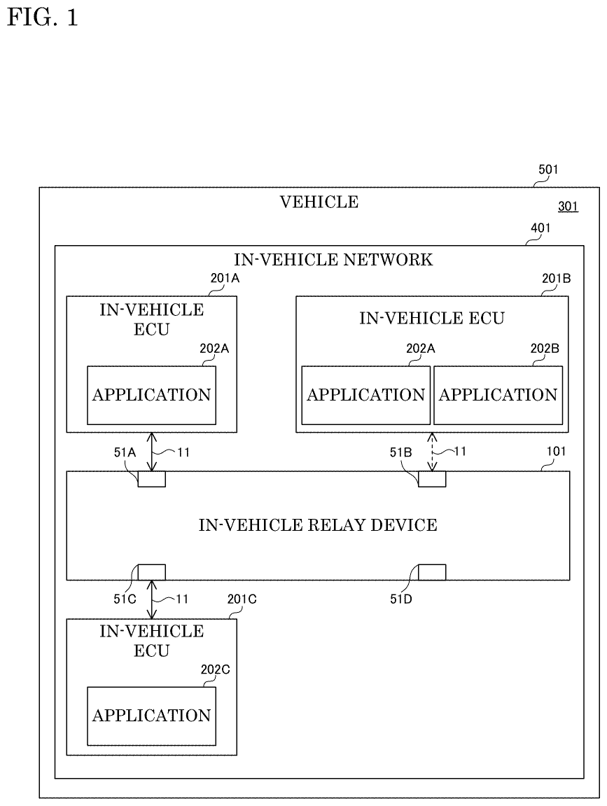

FIG. 1 is a diagram showing an example of the configuration of an in-vehicle communication system according to an embodiment of the present disclosure. Referring to FIG. 1, an in-vehicle communication system 301 includes an in-vehicle relay device 101 and a plurality of in-vehicle ECUs (Electronic Control Units) 201. The in-vehicle communication system 301 is installed in a vehicle 501. The in-vehicle ECUs 201 are an example of in-vehicle functional units installed in the vehicle 501.

Examples of the in-vehicle ECUs 201 include an automatic driving ECU, an engine ECU, a door lock ECU, and a TCU (Telematics Communication Unit). Note that the in-vehicle functional units are not limited to the in-vehicle ECUs 201, and may be sensors, a navigation device, a human machine interface, cameras, or the like.

In the example shown in FIG. 1, the in-vehicle communication system 301 is provided with in-vehicle ECUs 201A, 201B, and 201C, as the plurality of in-vehicle ECUs 201.

Note that the in-vehicle communication system 301 is not limited to being provided with three in-vehicle ECUs 201, and need only be provided with two or more in-vehicle ECUs 201.

The in-vehicle relay device 101 and the plurality of in-vehicle ECUs 201 constitute an in-vehicle network 401.

Hereinafter, an in-vehicle functional unit that is newly added to the in-vehicle network 401 will also be referred to as a new functional unit. The in-vehicle network 401 including a new functional unit will also be referred to as a new network, and the in-vehicle network 401 before the new functional unit is added will also be referred to as an existing network. Further, in-vehicle functional units included in the existing network will also be referred to as existing functional units.

In the example shown in FIG. 1, the in-vehicle ECU 201B is an example of a new functional unit, and the in-vehicle ECUs 201A and 201C are examples of existing functional units. Also, in FIG. 1, the dashed double-headed arrow indicates that the in-vehicle ECU 201B and the in-vehicle relay device 101 are not connected.

Applications 202 are installed in the in-vehicle ECUs 201A, 201B, and 201C. More specifically, an application 202A is installed in the in-vehicle ECU 201A, the application 202A and an application 202B are installed in the in-vehicle ECU 201B, and an application 202C is installed in the in-vehicle ECU 201C, as the applications 202.

In the in-vehicle network 401, the in-vehicle ECUs 201 are connected to the in-vehicle relay device 101 via, for example, an Ethernet (registered trademark) cable 11. Each in-vehicle ECU 201 is connected to the other in-vehicle ECUs 201 via the Ethernet cable 11 and the in-vehicle relay device 101.

The in-vehicle relay device 101 is, for example, a switch device, and performs relay processing for relaying data between the plurality of in-vehicle ECUs 201 connected thereto.

More specifically, the in-vehicle relay device 101 performs relay processing of Ethernet frames (hereinafter also simply referred to as “frames”) that are exchanged between the in-vehicle ECUs 201 connected via the Ethernet cable 11, in accordance with, for example, Ethernet communication standards.

Note that the in-vehicle communication system 301 is not limited to having a configuration in which frame relay processing is performed according to the Ethernet communication standard, but may have a configuration in which frame relay is performed according to a communication standard such as CAN (Controller Area Network) (registered trademark), CAN FD (CAN with Flexible Data Rate), FlexRay (registered trademark), MOST (Media Oritend System Transport) (registered trademark), LIN (Local Interconnect Network), or the like.

### In-Vehicle Relay Device

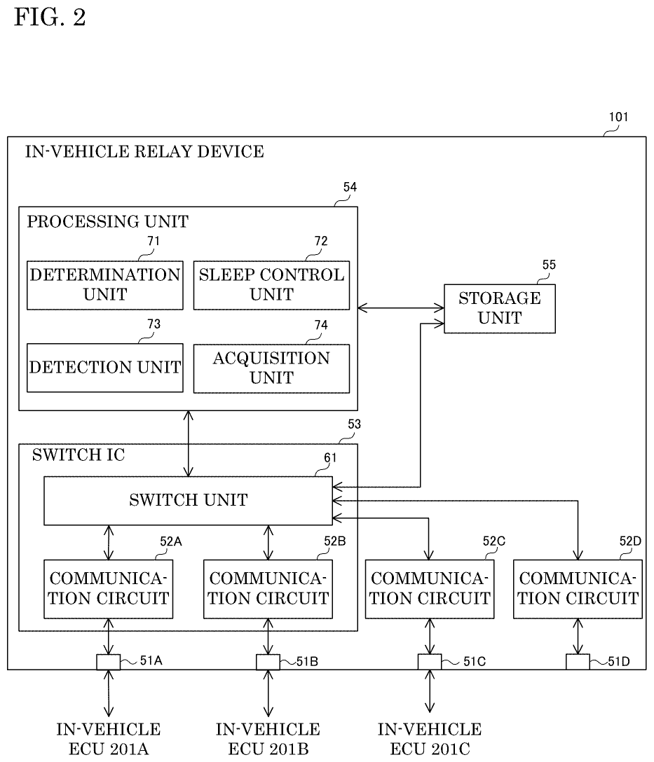

FIG. 2 is a diagram showing an example of the configuration of the in-vehicle relay device according to the embodiment of the present disclosure. Referring to FIGS. 1 and 2, the in-vehicle relay device 101 is provided with a plurality of communication ports 51, a plurality of communication circuits 52, a switch IC (Integrated Circuit) 53, a processing unit 54, and a storage unit 55.

The processing unit 54 includes a determination unit 71, a sleep control unit 72, a detection unit 73, and an acquisition unit 74. The processing unit 54 is realized by, for example, a processing circuitry including one or more processors. The storage unit 55 is, for example, a non-volatile memory included in the processing circuitry.

The plurality of communication ports 51 are respectively capable of connecting the plurality of in-vehicle ECUs 201. The communication ports 51 are, for example, terminals to which the Ethernet cable 11 is connectable.

More specifically, the in-vehicle relay device 101 is provided with four communication ports 51A, 51B, 51C, and 51D, as the plurality of communication ports 51. In the in-vehicle relay device 101, the in-vehicle ECUs 201A, 201B, and 201C are respectively connected to the communication ports 51A, 51B, and 51C via the Ethernet cable 11.

The plurality of communication circuits 52 are provided respectively corresponding to the plurality of communication ports 51. More specifically, the in-vehicle relay device 101 is provided with four communication circuits 52A, 52B, 52C, and 52D, as the plurality of communication circuits 52. The communication circuits 52A, 52B, 52C, and 52D are provided respectively corresponding to the communication

The communication circuits 52 can communicate with the in-vehicle ECUs 201 via the corresponding communication ports 51. More specifically, the communication circuit 52A is capable of communicating with the in-vehicle ECU 201A via the communication port 51A, the communication circuit 52B is capable of communicating with the in-vehicle ECU 201B via the communication port 51B, and the communication circuit 52C is capable of communicating with the in-vehicle ECU 201C via the communication port 51C.

In the example shown in FIG. 2, the in-vehicle relay device 101 is provided with the switch IC 53. The switch IC 53 includes the communication circuits 52A and 52B and a switch unit 61.

In this way, the communication circuits 52A and 52B are provided inside the switch IC 53. That is, the communication circuits 52A and 52B are built into the switch IC 53. On the other hand, the communication circuit 52C is provided outside the switch IC 53. That is, the communication circuit 52C is externally attached to the switch IC 53.

Note that the communication circuits 52A and 52B are not limited to being built into the switch IC 53 and may be externally attached to the switch IC 53. Also, the communication circuits 52C and 52D are not limited to being externally attached to the switch IC 53 and may be built into the switch IC 53.

Also, the communication circuits 52 that are built into the switch IC 53 are not limited to being the two communication circuits 52A and 52B, and one communication circuit 52 or three or more communication circuits 52 may be built into the switch IC 53. Also, the communication circuits 52 that are externally attached to the switch IC 53 are not limited to the two communication circuits 52C and 52D, and one communication circuit 52 or three or more communication circuits 52 may be externally attached to the switch IC 53.

The switch IC 53 operates as, for example, an L2 switch. The switch unit 61 in the switch IC 53 relays frames that are transmitted and received between the in-vehicle ECUs 201.

More specifically, each communication circuit 52, upon receiving a frame addressed to another in-vehicle ECU 201 from the in-vehicle ECU 201 connected to the corresponding communication port 51, outputs the received frame to the switch unit 61.

An address table indicating the correspondence relationship between destination MAC (Media Access Control) addresses and the communication ports 51 is saved in the storage unit 55.

The switch unit 61, upon receiving a frame addressed to an in-vehicle ECU 201 from a communication circuit 52, specifies the communication port 51 corresponding to the destination MAC address included in the frame, with reference to the address table in the storage unit 55. The switch unit 61 then transmits the frame received from the communication circuit 52 to the destination in-vehicle ECU 201 via the communication circuit 52 corresponding to the specified communication port 51 and the specified communication port 51.

A communication circuit 52, upon receiving a frame addressed to the in-vehicle relay device 101 from the in-vehicle ECU 201 connected via the corresponding communication port 51, outputs the received frame to the switch unit 61. The switch unit 61 outputs the frame received from the communication circuit 52 to the processing unit 54.

The processing unit 54 creates a frame addressed to an in-vehicle ECU 201 and outputs the created frame to the switch unit 61. The switch unit 61, upon receiving the frame from the processing unit 54, specifies the communication port 51 corresponding to the destination MAC address included in the frame, with reference to the address table saved in the storage unit 55. The switch unit 61 then transmits the frame received from the processing unit 54 to the destination in-vehicle ECU 201 via the communication circuit 52 corresponding to the specified communication port 51 and the specified communication port 51.

The switch unit 61 includes a plurality of terminals (not shown) that are respectively connected to the plurality of communication circuits 52, for example. A unique port number is assigned to each terminal.

### Sleep Mode and Wakeup Mode

The in-vehicle relay device 101 and the in-vehicle ECUs 201 transition from the wakeup mode to the sleep mode and transition from the sleep mode to the wakeup mode. The in-vehicle relay device 101 and the in-vehicle ECUs 201, in the wakeup mode, communicate with other devices in the in-vehicle communication system 301, and, in the sleep mode, stop communication with other devices in the in-vehicle communication system 301. Here, the sleep mode is a mode in which power consumption is smaller than in the wakeup mode, due to stopping some of the functions of the device, stopping power supply to the device, or reducing the clock frequency in the device.

For example, in the in-vehicle relay device 101 and each of the in-vehicle ECUs 201, a sleep condition which is a condition for transitioning to the sleep mode and a wakeup condition which is a condition for transitioning to the wakeup mode are set in advance.

Examples of sleep conditions include the ignition of the vehicle 501 being turned off, and the vehicle 501 stopping and parking. Also, examples of wakeup conditions include the ignition of the vehicle 501 being turned on and the vehicle 501 starting to travel.

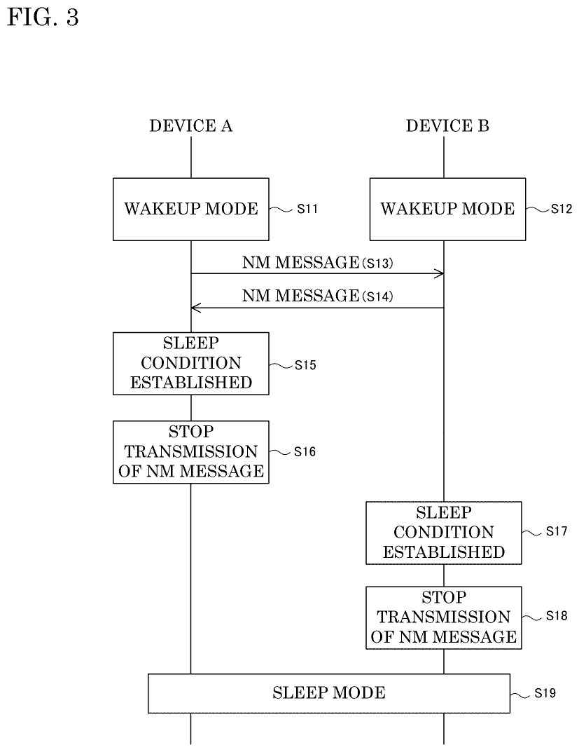

FIG. 3 is a diagram showing an example of a sequence of sleep processing in an in-vehicle communication system according to an embodiment of the present disclosure. In FIG. 3, “device A” and “device B” are the in-vehicle relay device 101 and an in-vehicle ECU 201.

Referring to FIG. 3, first, the device A and the device B, in the wakeup mode (steps S11 and S12), transmit a frame in which an NM (Network Management) message compliant with AUTOSAR (AUTomotive Open System ARchitecture) is stored to devices in the in-vehicle communication system 301, for example. Specifically, the device A and the device B broadcast a frame in which an NM message is stored to the devices to enable alive supervision (steps S13 and S14).

Next, the device A, in the case of the sleep condition thereof being established in the wakeup mode (step S15), stops transmitting the NM message (step S16).

Also, the device B, in the case of the sleep condition thereof being established in the wakeup mode (step S17), stops transmitting the NM message (step S18).

Next, if the device A and the device B do not receive an NM message from another device in the in-vehicle communication system 301 before a predetermined time elapses after stopping transmission of the NM message, the device A and the device B transition to the sleep mode (step S19).

In this way, the power consumption of the device A and the device B can be reduced, by switching the state of the device A and the device B from wakeup mode to the sleep mode using NM messages.

Note that, in the sleep mode (step S19), the device A and the device B, in the case of the respective wakeup condition thereof being established, transition to the wakeup mode and start regular transmission of the NM message. Also, the device A and the device B, in the case of receiving, in the sleep mode (step S19), a wakeup request from another device in the in-vehicle communication system 301, transition to the wakeup mode.

### Determination Unit

Referring again to FIG. 2, the determination unit 71 in the in-vehicle relay device 101 determines whether the sleep condition of the communication circuits 52 is established and whether the wakeup condition of the communication circuits 52 is established.

More specifically, the determination unit 71 monitors the state of the vehicle 501 and performs determination processing for determining whether the sleep condition of the communication circuits 52 is established and whether the wakeup condition of the communication circuits 52 is established, based on the monitoring result. The determination unit 71 performs the determination processing regularly, for example, and notifies the determination result to the sleep control unit 72.

### Sleep Control Unit

The sleep control unit 72 transitions the communication circuits 52 to the sleep mode. Also, the sleep control unit 72 transitions the communication circuits 52 to the wakeup mode.

More specifically, when the operation mode of the communication circuit 52 is the wakeup mode and a notification that the sleep condition has been established is received from the determination unit 71, the sleep control unit 72 transitions the communication circuits 52 to the sleep mode.

When the operation mode of a communication circuit 52 is the sleep mode and a notification that the wakeup condition has been established is received from the determination unit 71, the sleep control unit 72 transitions the communication circuits 52 to the wakeup mode.

Also, the sleep control unit 72, in the case of receiving a wakeup request from an in-vehicle ECU 201 via a communication port 51, a communication circuit 52, and the switch unit 61, transitions the communication circuit 52 operating in the sleep mode to the wakeup mode. Hereinafter, the wakeup request that is transmitted by an in-vehicle ECU 201 to the in-vehicle relay device 101 will also be referred to as “wakeup request W1”.

The in-vehicle relay device 101 and the in-vehicle ECU 201 then establish a communication connection with each other, by exchanging frames containing various information.

Also, the sleep control unit 72 performs control for transitioning the in-vehicle ECUs 201 to the wakeup mode. More specifically, when an in-vehicle ECU 201 operating in the sleep mode is the in-vehicle ECU 201 to be woken up, for example, the sleep control unit 72 transmits a wakeup request to that in-vehicle ECU 201 via the switch IC 53 and a communication port 51. Hereinafter, the wakeup request that is transmitted by the in-vehicle relay device 101 to an in-vehicle ECU 201 will also be referred to as “wakeup request W2”.

The in-vehicle EC 201, upon receiving the wakeup request W2 from the in-vehicle relay device 101, transitions to the wakeup mode.

All applications 202 installed in an in-vehicle ECU 201 stop operating when the operation mode of the in-vehicle ECU 201 is the sleep mode. An in-vehicle ECU 201, in the case of receiving a startup request for an application 202 from another device in the in-vehicle communication system 301, starts the application 202 designated in the startup request, among the applications 202 installed therein.

### Light Sleep Mode and Deep Sleep Mode

The sleep control unit 72 transitions the communication circuits 52 to a light sleep mode or a deep sleep mode. The light sleep mode is an example of a first sleep mode, and the deep sleep mode is an example of a second sleep mode. Note that the terms “first” and “second” do not imply priority.

More specifically, the in-vehicle relay device 101 includes a plurality of power supply lines (not shown) capable of supplying power to the communication circuits 52. For example, the in-vehicle relay device 101 includes a power supply line having a voltage of 12 V and a power supply line having a voltage of 3 V.

For example, when the operation mode of the communication circuit 52 is the light sleep mode, all of the plurality of power supply lines are connected to the communication circuit 52, and when the operation mode of the communication circuit 52 is the deep sleep mode, one of the plurality of power supply lines is disconnected from the communication circuit 52. That is, the deep sleep mode is a sleep mode in which power consumption in the communication circuit 52 is smaller than in the light sleep mode.

Also, for example, the communication circuit 52, when the operation mode thereof is the light sleep mode, stops transmission and reception of data with the in-vehicle ECU 201 connected via the corresponding communication port 51. Alternatively, when the operation mode of the communication circuit 52 is the light sleep mode, the processing unit 54 is capable of performing some processing such as reading the values of a register (not shown) of the communication circuit 52, but is unable to perform other processing with the communication circuit 52.

Here, the storage unit 55 stores sleep mode correspondence information indicating the sleep mode to respectively apply to the plurality of communication circuits 52. More specifically, the storage unit 55 stores a communication circuit table Tb1 that includes sleep mode correspondence information.

When the operation mode of the communication circuit 52 is the wakeup mode and a notification that the sleep condition has been established is received from the determination unit 71, the sleep control unit 72 determines the sleep mode to apply to the communication circuit 52, with reference to the communication circuit table Tb1 in the storage unit 55. The sleep control unit 72 then transitions the communication circuit 52 to the determined sleep mode.

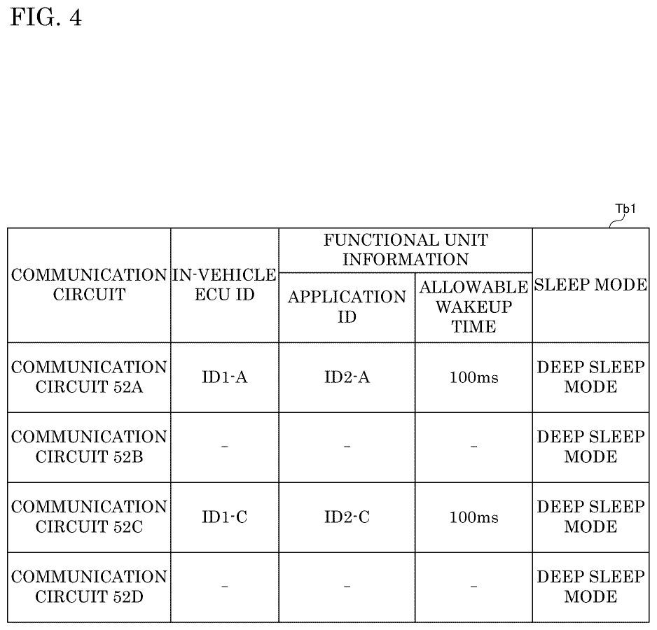

FIG. 4 is a diagram showing an example of the communication circuit table saved in the in-vehicle relay device according to the embodiment of the present disclosure.

FIG. 4 shows an example of the communication circuit table Tb1 saved in the storage unit 55 of the in-vehicle relay device 101 in the existing network. In the example shown in FIG. 4, the deep sleep mode is registered in the communication circuit table Tb1 as the type of sleep mode to apply to the communication circuits 52A and 52C.

Thus, in the existing network, the sleep control unit 72 transitions the communication circuits 52A and 52C to the deep sleep mode, when the operation mode of the communication circuits 52A and 52C is the wakeup mode and a notification that the sleep condition has been established is received from the determination unit 71.

Also, in the example shown in FIG. 4, the deep sleep mode is registered as the initial value in the communication circuit table Tb1, as the type of sleep mode to apply to the communication circuits 52B and 52D respectively corresponding to the communication ports 51B and 51D to which an in-vehicle ECU 201 is not connected. Note that “in-vehicle ECU ID” and “functional unit information” shown in FIG. 4 will be described later.

### Detection Unit

The detection unit 73 detects the addition of new functional units to the in-vehicle network 401. Here, the detection unit 73 detects the in-vehicle ECU 201B connected to the communication port 51B by the user.

More specifically, for example, the in-vehicle ECU 201B, when connected to the communication port 51B, transmits connection request information for requesting communication connection in the in-vehicle network 401 to the in-vehicle relay device 101.

The detection unit 73, upon receiving the connection request information from the in-vehicle ECU 201B via the switch IC 53, performs authentication processing on the in-vehicle ECU 201B, using an ID and an authentication password that are included in the connection request information.

The detection unit 73, upon successfully authenticating the in-vehicle ECU 201B, transmits a frame including authentication successful information indicating that authentication was successful to the in-vehicle ECU 201B via the switch IC 53.

The detection unit 73, upon successfully authenticating the new functional unit as described above, outputs detection information indicating the ID of the new functional unit, the port number corresponding to the new functional unit, and the like to the acquisition unit 74.

When authentication processing of the in-vehicle ECU 201B by the detection unit 73 is successful, the in-vehicle relay device 101 and the new functional unit perform transmission and reception of NM messages regularly, for example.

Note that the detection unit 73 may be configured to broadcast a search message for detecting a new functional unit via the switch IC 53 regularly, for example. In this case, the new functional unit receives the search message and transmits connection request information as the response to the received search message.

### Description of Problem

Given that the deep sleep mode involves disconnecting a power supply line, transitioning to the wakeup mode takes a long time compared to the light sleep mode.

In the in-vehicle communication system 301, an allowable time for each application 202 to start (hereinafter also referred to as “allowable wakeup time”) is set.

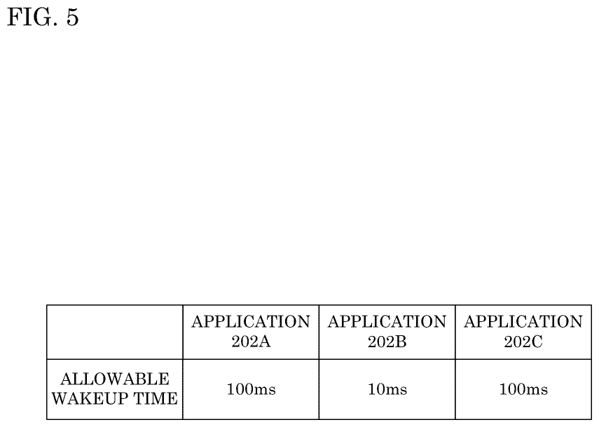

FIG. 5 is a diagram showing an example of the allowable wakeup time of each application in the in-vehicle communication system according to the embodiment of the

In the example shown in FIG. 5, the allowable wakeup time of the application 202A is “100 ms”, the allowable wakeup time of the application 202B is “10 ms”, and the allowable wakeup time of the application 202C is “100 ms”. That is, in the example shown in FIG. 5, the allowable wakeup times of the applications 202A and 202C are longer than the allowable wakeup time of the application 202B.

The in-vehicle ECUs 201A and 201B in which the application 202A having a long allowable wakeup time is installed respectively communicate with the communication circuits 52A and 52B. Also, the in-vehicle ECU 201C in which the application 202C having a long allowable wakeup time is installed communicates with the communication circuit 52C. Thus, it is conceivable to apply the deep sleep mode to the communication circuits 52A, 52B, and 52C.

However, in the examples shown in FIGS. 1 and 2, the in-vehicle ECU 201B has the application 202B is installed therein. The allowable wakeup time of the application 202B is shorter than the allowable wakeup time of the application 202A. Here, consider the case where the sleep control unit 72 transitions the communication circuit 52B operating in the deep sleep mode to the wakeup mode. In this case, when the time required for the communication circuit 52B to transition to the wakeup mode exceeds the allowable wakeup time “10 ms” of the application 202B, despite not exceeding the allowable wakeup time of the application 202A, operation in the new network becomes unstable. Specifically, the in-vehicle ECU 201B could possibly not be able to communicate via the in-vehicle relay device 101 with another in-vehicle ECU 201 that has transmitted a startup request for the application 202B installed in the in-vehicle ECU 201B.

Also, the sleep control unit 72 is unable to apply sleep control individually to the communication circuits 52A and 52B built into the switch IC 53, due to specification constraints of the hardware or the like of the in-vehicle relay device 101, for example. That is, in the in-vehicle relay device 101, a common sleep mode needs to be applied to the communication circuits 52A and 52B.

In the example shown in FIG. 1, in the existing network, the in-vehicle ECU 201A in which the application 202A having a long allowable wakeup time is installed is connected to the communication port 51A corresponding to the communication circuit 52A, whereas the in-vehicle ECU 201B is not connected to the communication port 51B corresponding to the communication circuit 52B. Thus, in the example shown in FIG. 4, the sleep control unit 72 selects the deep sleep mode as the common sleep mode to apply to the communication circuits 52A and 52B in the existing network.

However, in the new network, in addition to the application 202A, the in-vehicle ECU 201B has the application 202B with a shorter allowable wakeup time than the application 202A installed therein. Thus, when the sleep control unit 72 transitions the communication circuit 52B operating in the deep sleep mode to the wakeup mode, operation in the new network becomes unstable, when the time required for the communication circuit 52B to transition to the wakeup mode exceeds the allowable wakeup time of the application 202B, despite not exceeding the allowable wakeup time of the application 202A, as described above.

In contrast, the in-vehicle relay device 101 according to the embodiment of the present disclosure solves such problems by a configuration and operations such as the following.

Referring again to FIGS. 1 and 2, the acquisition unit 74 acquires the identification information of the existing functional units. Hereinafter, as the identification information of the existing functional units, the IDs of the in-vehicle ECUs 201A, 201B, and 201C are assumed to be “ID1-A”, “ID1-B”, and “ID1-C”, respectively.

More specifically, the acquisition unit 74 transmits an information request notification for requesting the identification information of the existing functional units regularly or irregularly to the existing functional units via the switch IC 53, for example. The existing functional units transmit the respective IDs thereof to the in-vehicle relay device 101 as the response to the information request notification received from the in-vehicle relay device 101.

The acquisition unit 74, upon receiving the identification information of each existing functional unit via the switch IC 53, registers the identification information of the existing functional unit in the communication circuit table Tb1 saved in the storage unit 55, in association with the communication circuit 52 corresponding to the communication port 51 that received the identification information.

Referring again to FIG. 4, the ID of the in-vehicle ECU 201 that communicates with the communication circuit 52A is “ID1-A”, and the ID of the in-vehicle ECU 201 that communicates with the communication circuit 52C is “ID1-C”.

The acquisition unit 74 acquires the functional unit information of the existing functional units. More specifically, for example, the acquisition unit 74 regularly or irregularly transmits an information request notification for requesting the functional unit information of the existing functional units to the existing functional units via the switch IC 53. The existing functional units transmit the respective functional unit information thereof to the in-vehicle relay device 101, as the response to the information request notification received from the in-vehicle relay device 101.

The acquisition unit 74, upon receiving the functional unit information of each existing functional unit via the switch IC 53, registers the functional unit information of the existing functional unit in the communication circuit table Tb1 saved in the storage unit 55, in association with the communication circuit 52 corresponding to the communication port 51 to which the existing functional unit is connected. In this way, the storage unit 55 stores function correspondence information indicating the correspondence relationship between the communication circuit 52 corresponding to the communication port 51 to which each existing functional unit is connected and the functional unit information of the existing functional unit. In other words, the communication circuit table Tb1 includes function correspondence information.

The functional unit information of each existing functional unit includes application information relating to applications installed in the existing functional unit. Specifically, the application information includes information relating to the type of application 202 and information relating to the allowable wakeup time. The information relating to the type of application 202 includes, for example, the ID (hereinafter also referred to as “application ID”) of the application 202.

Hereinafter, the IDs of the applications 202A, 202B, and 202C are assumed to be “ID2-A”, “ID2-B”, and “ID2-C”, respectively.

In the example shown in FIG. 4, the functional unit information of the in-vehicle ECU 201A is associated with the communication circuit 52A. Specifically, the application ID of the in-vehicle ECU 201 that communicates with the communication circuit 52A is “ID2-A”, and the allowable wakeup time is “100 ms”. The functional unit information of the in-vehicle ECU 201C is associated with the communication circuit 52C. Specifically, the application ID of the in-vehicle ECU 201 that communicates with the communication circuit 52C is “ID2-C”, and the allowable wakeup time is “100 ms”.

Note that, in the case where the identification information and the functional unit information of the existing functional units are saved in advance in the storage unit 55, the acquisition unit 74 may acquire the identification information and the functional unit information of the existing functional units from the storage unit 55.

When the addition of an in-vehicle ECU 201 to the in-vehicle network 401 including the existing functional units, that is, the existing network, is detected, the acquisition unit 74 acquires the functional unit information of the new functional unit whose addition is detected.

For example, the acquisition unit 74, upon receiving detection information from the detection unit 73, specifies the communication port 51 to which the new functional unit is connected, with reference to the port number included in the detection information. The acquisition unit 74 then transmits an information request notification for requesting the functional unit information of the new functional unit to the new functional unit via the switch IC 53 and the specified communication port 51. The new functional unit transmits the functional unit information thereof to the in-vehicle relay device 101, as the response to the information request notification received from the in-vehicle relay device 101.

The functional unit information of the new functional unit includes application information relating to applications installed in the new functional unit. When one application 202 is installed therein, the new functional unit transmits information including the ID of the application 202 and information relating to the allowable wakeup time to the in-vehicle relay device 101 as application information.

On the other hand, when a plurality of the applications 202 are installed therein, the new functional unit transmits information including the ID of each application 202 to the in-vehicle relay device 101 as application information. Also, when a plurality of applications 202 are installed therein, the new functional unit transmits information relating to the allowable wakeup time with the smallest value to the in-vehicle relay device 101 as application information.

The acquisition unit 74, in the case of acquiring the functional unit information of the new functional unit, performs update processing for registering the correspondence relationship between the communication circuit 52 corresponding to the communication port 51 to which the new functional unit is connected and the functional unit information of the new functional unit in the function correspondence information in the storage unit 55.

More specifically, the acquisition unit 74, in the case of acquiring the functional unit information of the in-vehicle ECU 201B, registers the functional unit information of the in-vehicle ECU 201B in the communication circuit table Tb1 saved in the storage unit 55, in association with the communication circuit 52B. The acquisition unit 74, in the case of completing the update processing, outputs an update completed notification indicating that the update processing has been completed to the sleep control unit 72.

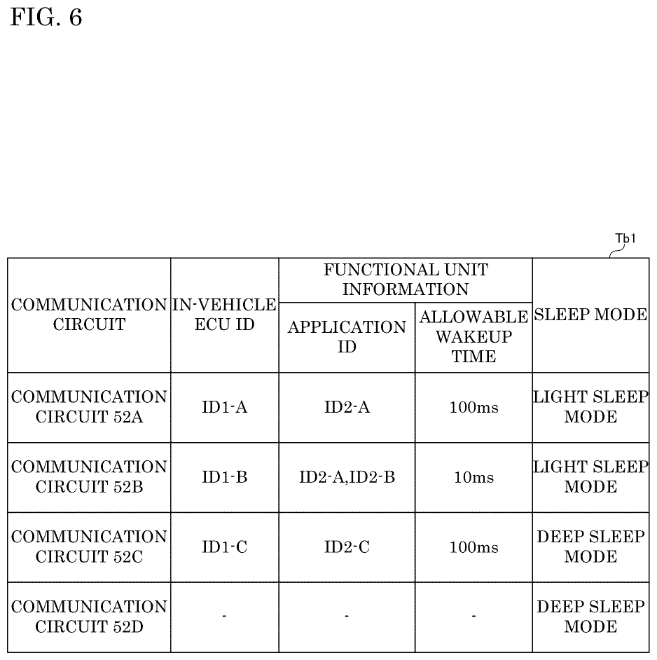

FIG. 6 is a diagram showing an example of the communication circuit table after the update processing by the in-vehicle relay device according to the embodiment Referring to FIG. 6, the application IDs of the in-vehicle ECU 201 that communicates with the communication circuit 52B are “ID2-A”, “ID2-B”, and the allowable wakeup time is “10 ms”.

Also, the acquisition unit 74, upon receiving detection information from the detection unit 73, registers the ID of the new functional unit included in the detection information in the communication circuit table Tb1.

More specifically, the acquisition unit 74, upon receiving detection information from the detection unit 73, specifies the communication circuit 52 that communicates with the new functional unit, with reference to the port number included in the detection information. The acquisition unit 74 then registers the ID of the new functional unit in the communication circuit table Tb1 saved in the storage unit 55, in association with the specified communication circuit 52.

In the example shown in FIG. 6, the ID of the in-vehicle ECU 201 that communicates with the communication circuit 52B is “ID1-B”.

### Selection of Sleep Mode

Referring again to FIGS. 1 and 2, the sleep control unit 72 performs selection processing for selecting, from among the plurality of types of sleep modes, the type of sleep mode to respectively apply to the communication circuit 52 corresponding to the communication port 51 to which the new functional unit is connected and to the communication circuits 52 corresponding to the communication ports 51 to which the existing functional units are connected, based on the functional unit information of the new functional unit acquired by the acquisition unit 74.

More specifically, a condition table Tb2 is saved in the storage unit 55. The condition table Tb2 is a table for the sleep control unit 72 to determine whether to select the deep sleep mode as the type of sleep mode to apply to the communication circuits 52.

The sleep control unit 72, upon receiving an update completed notification from the acquisition unit 74, performs selection processing, based on the communication circuit table Tb1 in the storage unit 55 after the update processing.

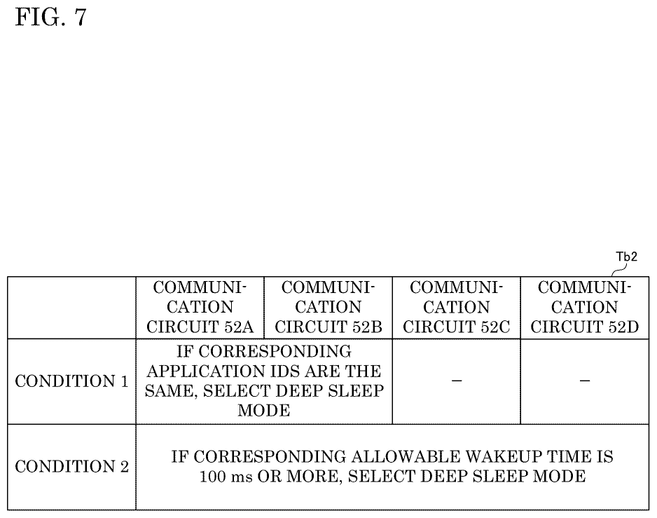

FIG. 7 is a diagram showing an example of the condition table saved by the in-vehicle relay device according to the embodiment of the present disclosure.

Referring to FIG. 7, “condition 1”, which is a condition relating to the type and number of applications 202, and “condition 2”, which is a condition relating to the allowable wakeup time, for example, are registered in the condition table Tb2. Condition 1 is a condition for determining whether to select the deep sleep mode as the type of sleep mode to apply to the communication circuits 52A and 52B built into the switch IC 53. Condition 2 is a condition for determining whether to select the deep sleep mode as the type of sleep mode to apply to the communication circuits 52A, 52B, 52C, and 52D.

The sleep control unit 72 performs the selection processing using condition 1 or condition 2. Hereinafter, the determination condition that the sleep control unit 72 uses in the selection processing will also be referred to as the “deep sleep application condition”.

For example, in selection processing that uses condition 1, the sleep control unit 72 selects the deep sleep mode as the type of sleep mode to apply to the communication circuits 52A and 52B, when the type of applications 202 installed in the existing functional units matches the type of applications 202 installed in the new functional unit, and the number of applications 202 installed in the existing functional units matches the number of applications 202 installed in the new functional unit.

In the example shown in FIG. 7, “If corresponding application IDs are the same, select deep sleep mode” is registered as condition 1. When the application IDs of the in-vehicle ECU 201A that communicates with the communication circuit 52A and the application IDs of the in-vehicle ECU 201B that communicates with the communication circuit 52B match each other, the sleep control unit 72 selects the deep sleep mode as the type of sleep mode to apply to the communication circuits 52A and 52B.

On the other hand, when the application IDs of the in-vehicle ECU 201A that communicates with the communication circuit 52A and the application IDs of the in-vehicle ECU 201B that communicates with the communication circuit 52B do not match each other, the sleep control unit 72 selects the light sleep mode as the type of sleep mode to apply to the communication circuits 52A and 52B.

In the example shown in FIG. 7, the application ID of the in-vehicle ECU 201A that communicates with the communication circuit 52A is “ID-A”, whereas the application ID of the in-vehicle ECU 201B that communicates with the communication circuit 52B is “ID-A, ID-B”. That is, the number of applications 202 installed in the in-vehicle ECU 201A and the number of applications 202 installed in the in-vehicle ECU 201B do not match each other. Thus, the sleep control unit 72 selects the light sleep mode as the type of sleep mode to apply to the communication circuits 52A and 52B.

More specifically, the sleep control unit 72 changes the type of sleep mode to apply to the “communication circuit 52A” and “communication circuit 52B” in the communication circuit table Tb1 from “deep sleep mode” to “light sleep mode”.

In selection processing that uses condition 2, the sleep control unit 72 selects the deep sleep mode as the type of sleep mode to apply to the communication circuit 52 when the allowable wakeup time of the in-vehicle ECU 201 that communicates with that communication circuit is equal to or greater than a predetermined threshold value.

In the example shown in FIG. 7, “If corresponding allowable wakeup time is 100 ms or more, select deep sleep mode” is registered as condition 2. Specifically, when the allowable wakeup time of the in-vehicle ECU 201 that communicates with the communication circuit 52 is 100 ms or more, the sleep control unit 72 selects the deep sleep mode as the type of sleep mode to apply to the communication circuit 52.

In the example shown in FIG. 7, the allowable wakeup time “10 ms” of the in-vehicle ECU 201B that communicates with the communication circuit 52B is shorter than 100 ms. Thus, the sleep control unit 72 selects the light sleep mode as the type of sleep mode to apply to the communication circuit 52B.

As described above, the sleep control unit 72 has, for example, registered the deep sleep mode as the type of sleep mode to apply to the communication circuits 52A and 52B built into the switch IC 53 in the existing network (hereinafter also referred to as the “initial mode state”).

In the examples shown in FIGS. 6 and 7, as described above, when a new functional unit is connected to the communication port 51B corresponding to at least one of the plurality of communication circuits 52 built into the switch IC 53, that is, the communication circuit 52B, in the initial mode state, the sleep control unit 72 selects the light sleep mode as the type of sleep mode to apply to the communication circuit 52B. In this case, the sleep control unit changes the type of sleep mode to apply to all of the remaining communication circuits 52 built into the switch IC 53, that is, the communication circuit 52A, from the deep sleep mode to the light sleep mode.

Specifically, the sleep control unit 72 changes the type of sleep mode to apply to the “communication circuit 52A” and the “communication circuit 52B” from “deep sleep mode” to “light sleep mode” in the communication circuit table Tb1.

### Flow of Operations

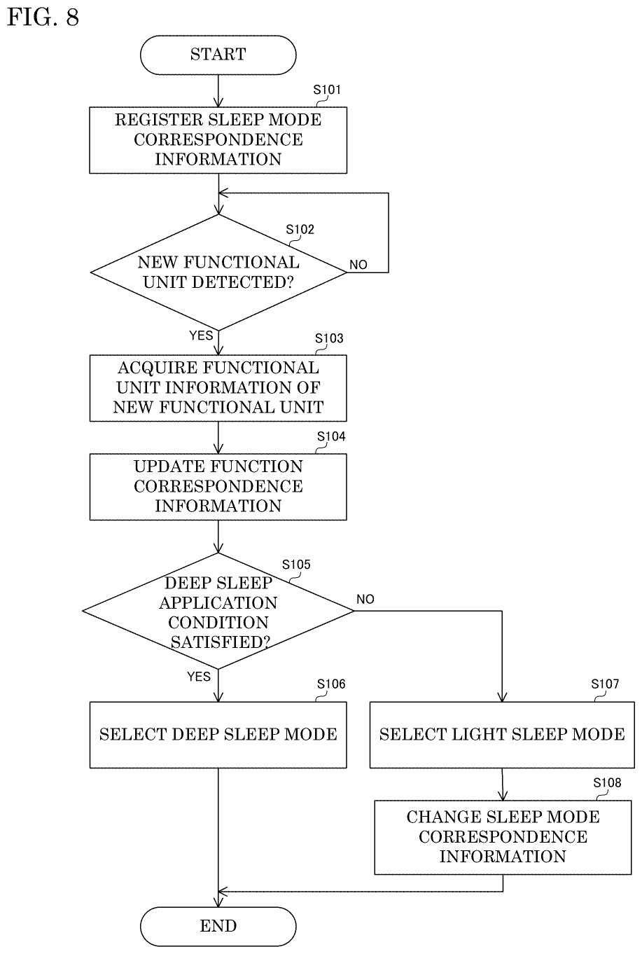

FIG. 8 is a flowchart defining an operation procedure of the selection processing by the in-vehicle relay device according to the embodiment of the present disclosure.

Referring to FIG. 8, first, the in-vehicle relay device 101 registers sleep mode correspondence information in the communication circuit table Tb11, in a state where the existing functional units are connected to some of the plurality of communication ports 51. Here, the existing functional units are assumed to be connected to the communication ports 51A and 51C. Also, in the communication circuit table Tb11, the deep sleep mode is assumed to be registered as the type of sleep mode to apply to the communication circuits 52A, 52B, 52C, and 52D (step S101).

Next, the in-vehicle relay device 101 waits for addition of a new functional unit to the in-vehicle network 401 (NO in step S102), and, upon detecting addition of a new functional unit (YES in step S102), acquires the functional unit information of the detected new functional unit (step S103).

Next, the in-vehicle relay device 101 updates the function correspondence information. For example, as described above, the in-vehicle relay device 101, upon acquiring the functional unit information of the new functional unit, registers the functional unit information of the new functional unit in the communication circuit table Tb1 saved in the storage unit 55, in association with the communication port 51 to which the new functional unit is connected (step S104).

Next, the in-vehicle relay device 101 refers to the communication circuit table Tb1 and the condition table Tb2 in the storage unit 55, and, when the deep sleep application condition is satisfied (YES in step S105), selects the deep sleep mode as the type of sleep mode to respectively apply to the communication circuit 52 corresponding to the communication port 51 to which the new functional unit is connected and to the communication circuits corresponding to the communication ports 51 to which the existing functional units are connected (step S106).

On the other hand, when the deep sleep application condition is not satisfied (NO in step S105), the in-vehicle relay device 101 selects the light sleep mode as the type of sleep mode to respectively apply to the communication circuit 52 corresponding to the communication port 51 to which the new functional unit is connected and to the communication circuits 52 corresponding to the communication ports 51 to which the existing functional units are connected (step S107).

Next, the in-vehicle relay device 101 changes the sleep mode correspondence information included in the communication circuit table Tb1. For example, as described above, the in-vehicle relay device 101, in the case of selecting the light sleep mode as the type of sleep mode to apply to each communication circuit 52, changes the type of sleep mode to apply to “communication circuit 52A” and “communication circuit 52B” from “deep sleep mode” to “light sleep mode” in the communication circuit table Tb1 (step S108).

Also, the in-vehicle relay device 101, in the case of detecting the addition of another new functional unit in the in-vehicle network 401 after the selection processing, newly performs the selection processing.

More specifically, referring to FIGS. 1 and 2, in the case of another new functional unit being added to the in-vehicle network 401, the acquisition unit 74 acquires the functional unit information of the other new functional unit. The sleep control unit 72 performs the selection processing, based on the functional unit information of the other new functional unit acquired by the acquisition unit 74 and the sleep correspondence information included in the communication circuit table Tb1 in the storage unit 55.

Specifically, the acquisition unit 74, upon receiving the detection information of an in-vehicle ECU 201 connected to the communication port 51D from the detection unit 73, acquires the functional unit information of that in-vehicle ECU 201.

The acquisition unit 74, upon acquiring the functional unit information of the in-vehicle ECU 201 connected to the communication port 51D, registers the functional unit information of the in-vehicle ECU 201 in the communication circuit table Tb1 saved in the storage unit 55, in association with the communication circuit 52 corresponding to the communication port 51D. The sleep control unit 72 then newly performs the selection processing using the communication circuit table Tb1 and the condition table Tb2 in the storage unit 55.

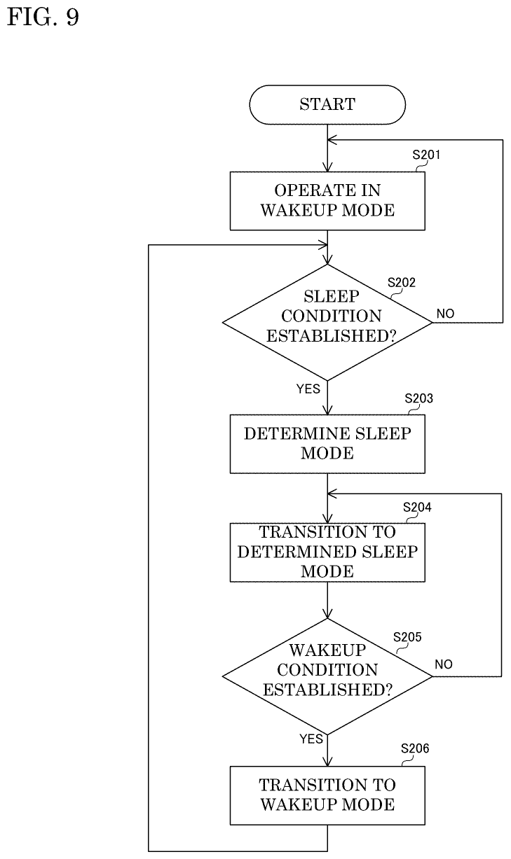

FIG. 9 is a flowchart defining an operation procedure of sleep control in the in-vehicle relay device according to the embodiment of the present disclosure.

Referring to FIG. 9, first, the in-vehicle relay device 101 operates in the wakeup mode (step S201), until the sleep condition thereof is established (NO in step S202).

Next, the in-vehicle relay device 101, upon the sleep condition thereof being established (YES in step S202), determines the sleep mode to apply to the communication circuits 52, with reference to the communication circuit table Tb1 in the storage unit 55 (step S203).

Next, the in-vehicle relay device 101 transitions the communication circuits 52 to the determined sleep mode and maintains the sleep mode (step S204), until the wakeup condition thereof is established (NO in step S205).

Next, the in-vehicle relay device 101, upon the wakeup condition thereof being established (YES in step S205), transitions the communication circuits 52 to the wakeup mode (step S201).

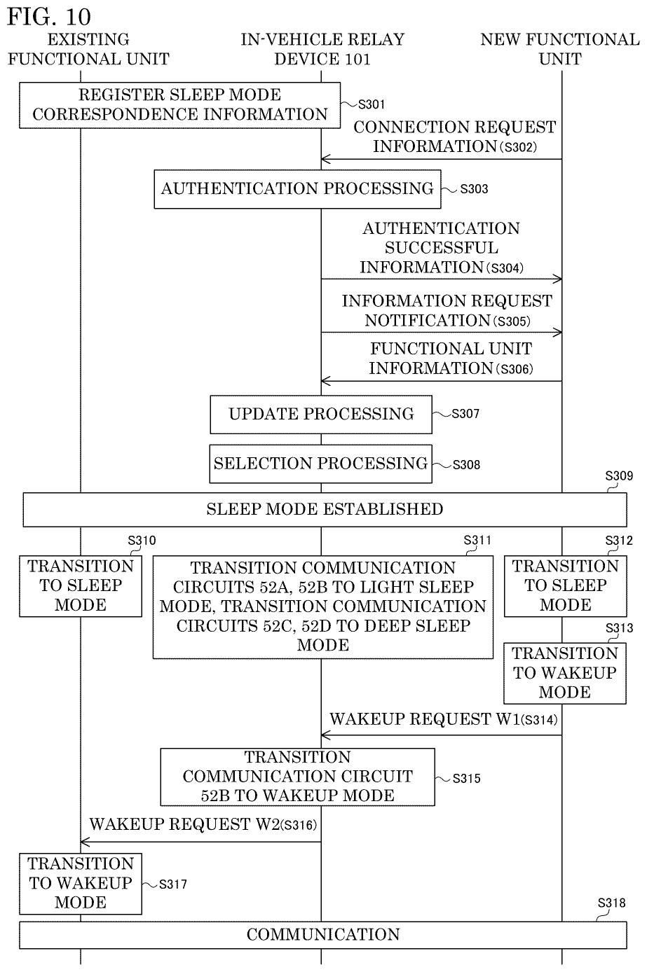

FIG. 10 is a diagram showing an example of a sleep control sequence in the in-vehicle communication system according to the embodiment of the present disclosure. Hereinafter, an example of sleep control in the in-vehicle relay device 101 when the existing functional units are connected to the communication ports 51A and 51C will be described.

Referring to FIG. 10, first, the in-vehicle relay device 101 registers sleep mode correspondence information in the communication circuit table Tb1, in a state where the existing functional units are connected to the communication ports 51A and 51C. Here, the deep sleep mode is assumed to be registered in the communication circuit table Tb1 as the type of sleep mode to apply to the communication circuits 52A, 52B, 52C, and 52D (step S301).

Next, a new functional unit added to the in-vehicle network 401 transmits connection request information to the in-vehicle relay device 101. Here, the new functional unit is assumed to be connected to the communication port 51B (step S302).

Next, the in-vehicle relay device 101, upon receiving the connection request information from the new functional unit, detects the new functional unit and performs authentication processing on the new functional unit (step S303).

Next, the in-vehicle relay device 101, upon successfully authenticating the new functional unit, transmits authentication successful information to the new functional unit (step S304).

Next, the in-vehicle relay device 101 transmits an information request notification for requesting functional unit information of the new functional unit (step S305).

Next, the new functional unit transmits the functional unit information of the new functional unit to the in-vehicle relay device 101, as the response to the information request notification (step S306).

Next, the in-vehicle relay device 101, upon acquiring the functional unit information of the new functional unit, performs update processing for updating the function correspondence information. For example, as described above, the in-vehicle relay device 101 registers the functional unit information of the new functional unit in the communication circuit table Tb1 in the storage unit 55, in association with the communication circuit 52 corresponding to the communication port 51 to which the new functional unit is connected (step S307).

Next, the in-vehicle relay device 101 performs selection processing for selecting, from among the plurality of types of sleep modes, the type of sleep mode to respectively apply to the communication circuit 52 corresponding to the communication port 51 to which the new functional unit is connected and to the communication circuits 52 corresponding to the communication ports 51 to which the existing functional units are connected, based on the function correspondence information after the update processing. Here, it is assumed that the in-vehicle relay device 101 changes the type of sleep mode to apply to the communication circuits 52A and 52B from the deep sleep mode to the light sleep mode and maintains the deep sleep mode as the type of sleep mode to apply to the communication circuits 52C and 52D (step S308).

Next, upon the sleep conditions of the existing functional units, the in-vehicle relay device 101, and the new functional unit being established (step S309), the existing functional units transition to the sleep mode (step S310).

Also, the in-vehicle relay device 101 transitions the communication circuits 52 to the sleep mode selected in the selection processing. More specifically, the in-vehicle relay device 101 transitions the communication circuits 52A and 52B to the light sleep mode and the communication circuits 52C and 52D to the deep sleep mode (step S311). Also, the new functional unit transitions to the sleep mode (step S312).

Next, the new functional unit, upon transitioning to the wakeup mode after the wakeup condition thereof is established (step S313), transmits a wakeup request W1 to the in-vehicle relay device 101 (step S314).

Next, the in-vehicle relay device 101, upon receiving the wakeup request W1 from the new functional unit, transitions the communication circuit 52 corresponding to the new functional unit to the wakeup mode. Here, the sleep control unit 72 in the in-vehicle relay device 101 transitions the communication circuit 52B to the wakeup mode (step S315).

Next, the in-vehicle relay device 101 transmits a wakeup request W2 to the existing functional units (step S316).

Next, the existing functional units, upon receiving the wakeup request W2 from the in-vehicle relay device 101, transition to the wakeup mode (step S317).

Next, the new functional unit and the existing functional units communicate with each other. For example, a communication circuit 52 in the in-vehicle relay device 101, upon receiving a frame addressed to an existing functional unit from the new functional unit via the corresponding communication port 51, outputs the received frame to the switch unit 61. The switch unit 61 transmits the frame received from the communication circuit 52 to the existing functional unit to which the frame is addressed (step S318).

Note that, in the in-vehicle relay device 101 according to the embodiment of the present disclosure, in the selection processing, the sleep control unit 72 is configured to select, from among the two sleep modes, the type of sleep mode to respectively apply to the communication circuits 52 corresponding to the new functional unit and the existing functional units, but the present disclosure is not limited thereto. In the selection processing, the sleep control unit 72 may be configured to select, from among three or more sleep modes, the type of sleep mode to respectively apply to the communication circuits 52 corresponding to the new functional unit and the existing functional units.

Note that, in the in-vehicle relay device 101 according to the embodiment of the present disclosure, the acquisition unit 74 is configured to acquire application information of the new functional unit, as functional unit information of the new functional unit, but the present disclosure is not limited thereto. For example, the acquisition unit 74 may acquire hardware information of the new functional unit as the functional unit information of the new functional unit.

Also, in the in-vehicle relay device 101 according to the embodiment of the present disclosure, the acquisition unit 74 is configured to acquire, as application information, information relating to the type of applications 202 and information relating to the allowable wakeup time, but the present disclosure is not limited thereto. For example, the acquisition unit 74 may acquire information relating to hardware constraints of the applications 202 as application information.

Also, in the in-vehicle relay device 101 according to the embodiment of the present disclosure, the acquisition unit 74 is configured to acquire the functional unit information of existing functional units and the functional unit information of new functional units, but the present disclosure is not limited thereto. A configuration may be adopted in which the acquisition unit 74 does not acquire the functional unit information of existing functional units, for example.

Also, in the in-vehicle relay device 101 according to the embodiment of the present disclosure, the storage unit 55 is configured to store the communication circuit table Tb1 containing function correspondence information and sleep correspondence information, but the present disclosure is not limited thereto. The storage unit 55 may separately store a table containing function correspondence information and a table including sleep correspondence information.

### Variations

In the in-vehicle relay device 101 according to the embodiment of the present disclosure, the sleep control unit 72 is configured to select, from among a plurality of types of sleep modes, the type of sleep mode to apply to the communication circuits 52A and 52B built into the switch IC 53, but the present disclosure is not limited thereto. The sleep control unit 72 may be configured to select, from among a plurality of types of sleep modes, the type of sleep mode to apply to communication circuits 52 that are externally attached to the switch IC 53.

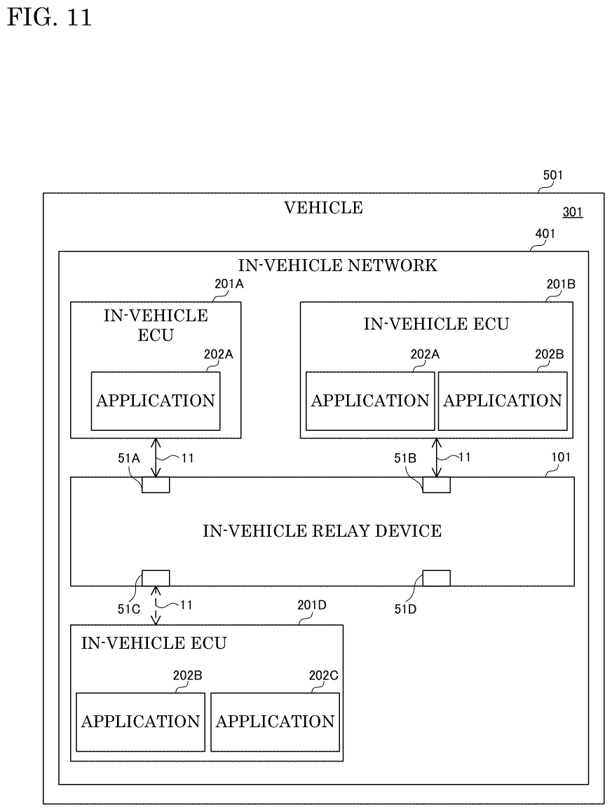

FIG. 11 is a diagram showing the configuration of a variation of the in-vehicle communication system according to the embodiment of the present disclosure.

Referring to FIG. 11, in the variation, the in-vehicle ECUs 201A and 201B are examples of existing functional units, and an in-vehicle ECU 201D is an example of a new functional unit. Also, in FIG. 11, the dashed double-headed arrow indicates that the in-vehicle ECU 201D and the in-vehicle relay device 101 are not connected.

In the variation, applications 202B and 202C are installed in the in-vehicle ECU 201D.

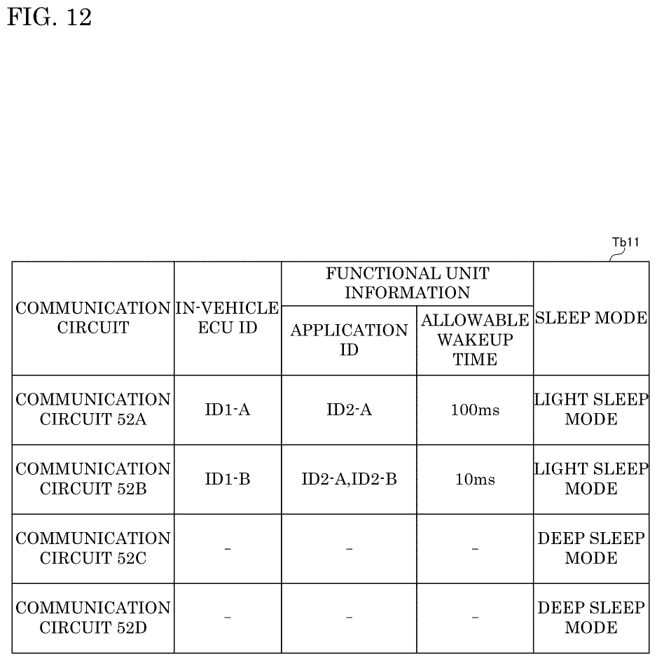

FIG. 12 is a diagram showing a communication circuit table saved by the variation of the in-vehicle relay device according to the embodiment of the present disclosure.

FIG. 12 shows an example of a communication circuit table Tb11 saved in the storage unit 55 of the variation of the in-vehicle relay device 101 in an existing network. In the example shown in FIG. 12, the light sleep mode is registered in the communication circuit table Tb11 as the type of sleep mode to apply to the communication circuits 52A and 52B.

Also, in the example shown in FIG. 12, the deep sleep mode is registered as the initial value in the communication circuit table Tb11, as the sleep mode to apply to the communication circuits 52C and 52D respectively corresponding to the communication ports 51C and 51D to which an in-vehicle ECU 201 are not connected.

When addition of the in-vehicle ECU 201D to the existing network is detected, the acquisition unit 74 transmits an information request notification for requesting the functional unit information of the in-vehicle ECU 201D to the in-vehicle ECU 201D via the switch IC 53. The in-vehicle ECU 201D transmits the functional unit information thereof to the in-vehicle relay device 101, as the response to the information request notification received from the in-vehicle relay device 101. Here, the in-vehicle ECU 201D is assumed to be connected to the communication port 51C by the user.

The acquisition unit 74, in the case of acquiring the functional unit information of the in-vehicle ECU 201D, registers the functional unit information of the in-vehicle ECU 201D in the communication circuit table Tb11 saved in the storage unit 55, in association with the communication circuit 52C corresponding to the communication port 51C to which the in-vehicle ECU 201D is connected.

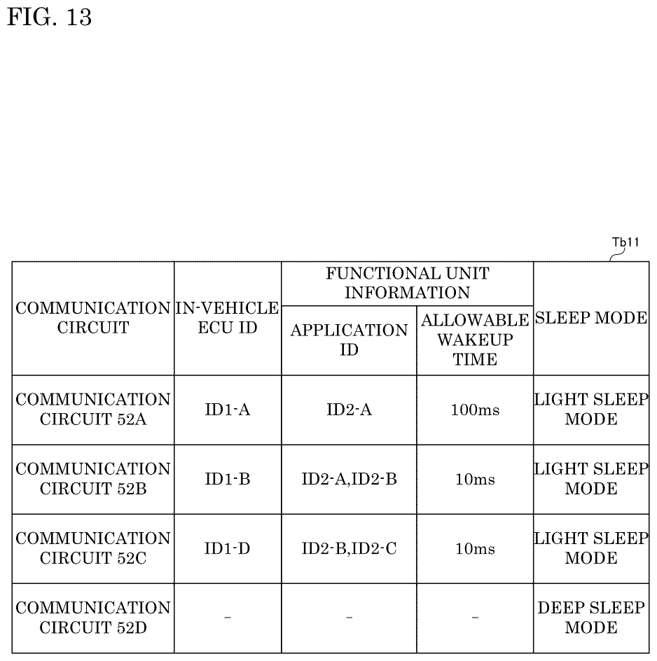

FIG. 13 is a diagram showing the communication circuit table after update processing by the variation of the in-vehicle relay device according to the embodiment of the present disclosure.

Referring to FIG. 13, the application IDs of the in-vehicle ECU 201D that communicates with the communication circuit 52C are “ID2-B, ID2-C”, and the allowable wakeup time is “10 ms”. Also, the ID of the in-vehicle ECU 201D that communicates with the communication circuit 52C is “ID1-D”.

In the variation, the sleep control unit 72, upon receiving an update completed notification from the acquisition unit 74, refers to the communication circuit table Tb11 after the update processing and the condition table Tb2 in the storage unit 55. The sleep control unit 72 then determines that the allowable wakeup time of the in-vehicle ECU 201D that communicates with the communication circuit 52C is shorter than 100 ms and selects the light sleep mode as the type of sleep mode to apply to the communication circuit 52C.

Specifically, the sleep control unit 72 changes the type of sleep mode to apply to the “communication circuit 52C” from “deep sleep mode” to “light sleep mode” in the communication circuit table Tb11.

Also, in the variation, the sleep control unit 72, in the new network, maintains the type of sleep mode to respectively apply to the communication circuits 52A and 52B built into the switch IC 53 in the sleep mode applied in the existing network. In the example shown in FIG. 13, the sleep control unit 72 maintains the type of sleep mode to apply to “communication circuit 52A” and “communication circuit 52B” in “light sleep mode”.

The foregoing embodiments are to be construed in all respects as illustrative and not restrictive. The scope of the present disclosure is defined by the claims rather than the description above, and is intended to include all modifications within the meaning and scope of the claims and equivalents thereof.

Each type of processing (each function) in the above embodiment is realized by a processing circuitry including one or more processors. The processing circuitry may be constituted by an integrated circuit or the like that combines one or more memories, various analog circuits, and various digital circuits, in addition to the one or more processors. The one or more memories store programs (instructions) that cause the one or more processors to execute each type of the above processing. The one or more processors may execute each type of the above processing according to the programs read out from the one or more memories, or may execute each type of the above processing according to a logic circuit designed in advance to execute each type of the above processing. The processors may be various processors suitable for computer control, such as a CPU (Central Processing Unit), a GPU (Graphics Processing Unit), a DSP (Digital Signal Processor), an FPGA (Field Programmable Gate Array), and an ASIC (Application Specific Integrated Circuit). Note that a plurality of physically separated processors may cooperate with each other to execute each type of the above processing. For example, the processors installed in a plurality of physically separate computers may cooperate with each other via a network such as a LAN (Local Area Network), a WAN (Wide Area Network), or the internet to execute each type of the above processing. The above programs may be installed in the memories via the network from an external server device or the like, or may be distributed in a state stored on a recording medium such as a CD-ROM (Compact Disc Read Only Memory), a DVD-ROM (Digital Versatile Disk Read Only Memory), or semiconductor memory, and installed in the memories from the recording medium.

The above description includes characteristics described in the following supplementary notes.

### Supplementary Note 1

An in-vehicle relay device including: a plurality of communication ports configured to be respectively connected to a plurality of in-vehicle functional units; a plurality of communication circuits provided respectively corresponding to the plurality of communication ports and configured to communicate with the in-vehicle functional units via the corresponding communication ports; and a processing circuitry, the processing circuitry being configured to acquire, when addition of one of the in-vehicle functional unit to an in-vehicle network including an existing functional unit, which is one or more of the in-vehicle functional units, is detected, functional unit information of a new functional unit, which is the in-vehicle functional unit whose addition is detected; and perform, based on the functional unit information of the new functional unit acquired by the acquisition unit, selection processing for selecting, from among a plurality of types of sleep modes, a type of sleep mode to respectively apply to the communication circuit corresponding to the communication port to which the new functional unit is connected and to the communication circuit corresponding to the communication port to which the existing functional unit is connected.

1. An in-vehicle relay device comprising:
a plurality of communication ports configured to be respectively connected to a plurality of in-vehicle functional units;
a plurality of communication circuits provided respectively corresponding to the plurality of communication ports and configured to communicate with the in-vehicle functional units via the corresponding communication ports;
an acquisition unit configured to acquire, when addition of one of the in-vehicle functional unit to an in-vehicle network including an existing functional unit, which is one or more of the in-vehicle functional units, is detected, functional unit information of a new functional unit, which is the in-vehicle functional unit whose addition is detected; and
a sleep control unit configured to perform, based on the functional unit information of the new functional unit acquired by the acquisition unit, selection processing for selecting, from among a plurality of types of sleep modes, a type of sleep mode to respectively apply to the communication circuit corresponding to the communication port to which the new functional unit is connected and to the communication circuit corresponding to the communication port to which the existing functional unit is connected.

2. The in-vehicle relay device according to claim 1,
wherein the functional unit information includes application information relating to an application installed in the new functional unit, and
the sleep control unit performs the selection processing, based on the application information of the new functional unit acquired by the acquisition unit.

3. The in-vehicle relay device according to claim 2, wherein the application information includes information relating to a type of the application.

4. The in-vehicle relay device according to claim 2, wherein the application information includes information relating to an allowable time for the application to start.

5. The in-vehicle relay device according to claim 1,
wherein the acquisition unit further acquires functional unit information of the existing functional unit, and
the sleep control unit performs the selection processing, based on the functional unit information of the new functional unit and the functional unit information of the existing functional unit acquired by the acquisition unit.

6. The in-vehicle relay device according to claim 1, further including;
a storage unit configured to store function correspondence information indicating a correspondence relationship between the communication circuit corresponding to the communication port to which the existing functional unit is connected and the functional unit information of the existing functional unit,
wherein the acquisition unit, in a case of acquiring the functional unit information of the new functional unit, performs update processing for registering, in the function correspondence information in the storage unit, a correspondence relationship between the communication circuit corresponding to the communication port to which the new functional unit is connected and the functional unit information of the new functional unit, and
the sleep control unit performs the selection processing, based on the function correspondence information after the update processing.

7. The in-vehicle relay device according to claim 1, further including;
a storage unit configured to store sleep mode correspondence information indicating the sleep mode to respectively apply to the plurality of communication circuits,
wherein the acquisition unit, in a case of another new functional unit being added to the in-vehicle network, acquires functional unit information of the other new functional unit, and
the sleep control unit performs the selection processing, based on the functional unit information of the other new functional unit acquired by the acquisition unit and the sleep mode correspondence information in the storage unit.

8. The in-vehicle relay device according to claim 1,
wherein the plurality of types of sleep modes include a first sleep mode and a second sleep mode in which power consumption of the communication circuits is smaller than in the first sleep mode, and
when, in a state where the second sleep mode is selected as the sleep mode to apply to a predetermined plurality of the communication circuits, the new functional unit is connected to the communication port corresponding to at least one of the predetermined plurality of communication circuits, and the first sleep mode is selected as the sleep mode to apply to the communication circuit corresponding to the communication port to which the new functional unit is connected, the sleep control unit changes the sleep mode to apply to all of the remaining communication circuits of the predetermined plurality of communication circuits from the second sleep mode to the first sleep mode.

9. A sleep control method for use in an in-vehicle relay device including a plurality of communication ports configured to be respectively connected to a plurality of in-vehicle functional units, and a plurality of communication circuits provided respectively corresponding to the plurality of communication ports and configured to communicate with the in-vehicle functional units via the corresponding communication ports, the method comprising:
a step of acquiring, when addition of one of the in-vehicle functional units to an in-vehicle network including an existing functional unit, which is one or more of the in-vehicle functional units, is detected, functional unit information of a new functional unit, which is the in-vehicle functional unit whose addition is detected; and
a step of performing, based on the acquired functional unit information of the new functional unit, selection processing for selecting, from among a plurality of types of sleep modes, a type of sleep mode to respectively apply to the communication circuit corresponding to the communication port to which the new functional unit is connected and to the communication circuit corresponding to the communication port to which the existing functional unit is connected.

10. A computer program product for performing sleep control, the computer program product used in an in-vehicle relay device including a plurality of communication ports configured to be respectively connected to a plurality of in-vehicle functional units, and a plurality of communication circuits provided respectively corresponding to the plurality of communication ports and configured to communicate with the in-vehicle functional units via the corresponding communication ports, the computer program product comprising a non-transitory, machine-readable medium storing instructions which, when executed by at least one programmable processor, causes at least one programmable processor to perform operations comprising:
instructing an acquisition unit to acquire, when addition of one of the in-vehicle functional units to an in-vehicle network including an existing functional unit, which is one or more of the in-vehicle functional units, is detected, functional unit information of a new functional unit, which is the in-vehicle functional unit whose addition is detected; and
instructing a sleep control unit to perform, based on the functional unit information of the new functional unit acquired by the acquisition unit, selection processing for selecting, from among a plurality of types of sleep modes, a type of sleep mode to respectively apply to the communication circuit corresponding to the communication port to which the new functional unit is connected and to the communication circuit corresponding to the communication port to which the existing functional unit is connected.
